(19) United States
(12) Patent Application Publication
(10) Pub. No.: US 2020/0133658 A1
(43) Pub. Date: Apr. 30, 2020

(54) CHANGE GOVERNANCE USING BLOCKCHAIN

(71) Applicant: EMC IP HOLDING COMPANY LLC, Hopkinton, MA (US)

(72) Inventors: Siddharth Agrawal, Sambalpur (IN); Chetan Pudiyanda Somaiah, Bangalore (IN)

(21) Appl. No.: 16/175,200

(22) Filed: Oct. 30, 2018

(51) Int. Cl. G06F 8/70; G06F 8/36

(52) U.S. Cl. CPC G06F 8/70; G06F 8/36

(57) ABSTRACT

A method is used in maintaining a software project in computing environments. A software project maintenance module processes at least one transaction associated with source code of the software project, where the transaction requires validation by a plurality of contributors in a decentralized network. The software project maintenance module updates the decentralized network by adding the at least one processed transaction as a block in the decentralized network.

### BACKGROUND

### Technical Field

This application relates to change governance using blockchain in computing environments.

### Description of Related Art

There are a variety of source control repository tools that help software teams manage changes to source code over time.

### SUMMARY OF THE INVENTION

In accordance with one aspect of the invention is a method used in maintaining a software project in computing environments. A software project maintenance module processes at least one transaction associated with source code of the software project, where the transaction requires validation by a plurality of contributors in a decentralized network. The software project maintenance module updates the decentralized network by adding at least one processed transaction as a block in the decentralized network.

In accordance with one aspect of the invention is a system used in maintaining a software project in computing environments. A software project maintenance module processes at least one transaction associated with source code of the software project, where the transaction requires validation by a plurality of contributors in a decentralized network. The software project maintenance module updates the decentralized network by adding at least one processed transaction as a block in the decentralized network.

In accordance with another aspect of the invention, a computer program product comprising a computer readable medium is encoded with computer executable program code. The code enables execution across one or more processors for maintaining a software project in computing environments. A software project maintenance module processes at least one transaction associated with source code of the software project, where the transaction requires validation by a plurality of contributors in a decentralized network. The software project maintenance module updates the decentralized network by adding at least one processed transaction as a block in the decentralized network.

### BRIEF DESCRIPTION OF THE DRAWINGS

Features and advantages of the present technique will become more apparent from the following detailed description of exemplary embodiments thereof taken in conjunction with the accompanying drawings in which:

FIG. 1 illustrates an example decentralized network, in accordance with an embodiment of the present disclosure.

FIG. 2 an example of an embodiment of maintaining a software project in computing environments, in accordance with an embodiment of the present disclosure.

FIG. 3 illustrates an example flow chart of maintaining a software project, in accordance with an example of the present disclosure.

FIG. 4 illustrates an example embodiment of linking transactions using the blockchain network, in accordance with an embodiment of the present disclosure.

FIG. 5 is a block diagram of a computer, in accordance with an embodiment of the present disclosure.

FIG. 6 is a flow diagram illustrating processes that may be used in connection with techniques disclosed herein.

### DETAILED DESCRIPTION OF EMBODIMENT(S)

Described below is a technique for use in maintaining a software project in computing environments, which technique may be used to provide, among other things, processing, by a software project maintenance module, at least one transaction associated with source code of the software project, where the transaction requires validation by a plurality of contributors in a decentralized network, and updating the decentralized network by adding at least one processed transaction as a block in the decentralized network.

Source control repository tools typically have an administrator who has authority over the software code ownership. When a software project has a requirement change that needs to be performed, for example, after a scope lock date, that requirement change can be performed by the administrator without approval of other contributors (such as developers, testers, etc.) on the software team.

Conventional technologies do not provide a governance system for source control for software projects. Conventional technologies do not provide a system for all contributors to be synchronized with the status of the software project. Conventional technologies do not provide governance that allows the developers to have approval/denial rights with regard to proposed requirement changes.

Conventional technologies do not provide contributors with authority over a requirement change associated with a software project. Conventional technologies allow requirement changes to be performed without the approval of all contributors to the software project. Conventional technologies allow, for example, a product owner to change a requirement at any time, without the consent of all the contributors. The contributors do not have the ability to stop the product owner from changing the requirement. For example, if a software code change needs to be pushed through to a particular environment (such as from development to system integration testing), or if any requirement changes need to be performed on the software code, conventional technologies allow these changes to be made without the approval of the participating members of the software project. For example, a requirement change may come through 1 week before the software project is scheduled to move into production, such as when an administrator makes a software code change after a scope lock date. This means the developers are required to re-test all the associated software code. The result is that the developers are now under a tight schedule to perform the testing, and do not have any authority to approve or deny the software code change. The developers, being very familiar with the software project, may be aware that a given requirement change may cause problems in other areas of the software project. Therefore, their opinion to approve or deny the software changes is integral and valuable to the software project, and should be taken into consideration. Thus, embodiments disclosed herein provide governance for the software project, for example, where requirements cannot not be changed without the consent of all the contributors. The use of the permissioned blockchain network provides the necessary governance for the software project.

Conventional technologies do not provide a platform where all the contributors are synchronized with each and every change that happens within the software project. Conventional technologies do not provide a platform where each and every change to a software project happens with the mutual consent of all the contributors, and where all the contributors are updated through a dashboard as each transaction occurs.

Conventional technologies track changes in a sub project of a software project, such as a sprint, only if there are changes in a requirement, test case, defect, etc. However, conventional technologies cannot link two (or more) sprints even within the same software project. Conventional technologies do not provide the ability to trace back from any existing sprint to the start of the software project. Conventional technologies do not track requirement and/or software code changes, and present the state of the software code/software defect using blockchain technology.

By contrast, embodiments disclosed herein brings the contributors to a software project (i.e., product owners, technical project managers, software code developers, testers, database administrators, etc.) into mutual agreement to make the process more transparent by using permissioned blockchain technology for maintaining/managing the software project, and specifically for maintaining the source control for the software project.

In at least some implementations in accordance with the current technique as described herein, a software project maintenance module processes at least one transaction associated with source code of the software project, where the transaction requires validation by a plurality of contributors in a decentralized network. The software project maintenance module updates the decentralized network by adding at least one processed transaction as a block in the decentralized network.

Embodiments disclosed herein may be extended to any source code repository management tool. Embodiments disclosed herein, while explained using the example of source control of a software project, may be implemented in any process/environment that would benefit from a governance system for modifications/approvals, for example, such as a manufacturing process. Embodiments disclosed herein may be used in any process/environment that would benefit from mutual agreement among members.

In at least some implementations in accordance with the current technique described herein, the use of maintaining a software project in computing environments can provide one or more of the following advantages: providing a governance system for software projects source control, or for any process/environment that would benefit from a governance system for modifications/approvals, allowing all contributors to have authority over a requirement change associated with a software project, providing a system for all contributors to be synchronized with the status of the software project, providing a platform where all the contributors are synchronized with each and every change that happens within the software project, providing a platform where each change to a software project happens with the mutual consent of all the contributors, where all the contributors are updated through a dashboard as each transaction occurs, linking two (or more) sprints even within the same software project, providing the ability to trace back from any existing sprint to the start of the software project, tracking requirement and/or software code changes, and presenting the state of the software code/software defect using blockchain technology.

In contrast to conventional technologies, in at least some implementations in accordance with the current technique as described herein, a software project maintenance module processes at least one transaction associated with source code of the software project, where the transaction requires validation by a plurality of contributors in a decentralized network. The software project maintenance module updates the decentralized network by adding at least one processed transaction as a block in the decentralized network.

In an example embodiment of the current technique, the software project maintenance module provides a user interface allowing each of the plurality of contributors to monitor the processing of the transaction.

In an example embodiment of the current technique, the decentralized network is a permissioned blockchain network.

In an example embodiment of the current technique, the transaction occurs within a predetermined time period, and the transaction is a block in the permissioned blockchain network.

In an example embodiment of the current technique, each of the plurality of contributors is added as a participant to the permissioned blockchain network, and are provided with access to validate at least one transaction.

In an example embodiment of the current technique, a contributor is added to the permissioned blockchain network for transactions that the contributor is authorized to validate.

In an example embodiment of the current technique, the software project maintenance module initiates processing the transaction upon detecting a requirement change in the software project.

In an example embodiment of the current technique, processing the transaction is invoked by at least one of the plurality of contributors.

In an example embodiment of the current technique, the transaction is a requirement change to the software project, and the requirement change is committed when all the contributors have validated the requirement change.

In an example embodiment of the current technique, the transaction requires validation when the transaction is not occurring according to a predetermined schedule.

In an example embodiment of the current technique, the transaction is a sub project of the software project, and is linked to at least one previous transaction in the decentralized network.

In an example embodiment of the current technique, each of the contributors may access each of at least one previous transaction.

In an example embodiment of the current technique, each transaction comprises a code requirement, a portion of source code, and at least one test case.

In an example embodiment of the current technique, the portion of source code is tokenized and available for re-use within the software project and/or another software project.

In an example embodiment of the current technique, the software project maintenance module performs a comparison between at least one transaction and a previous transaction.

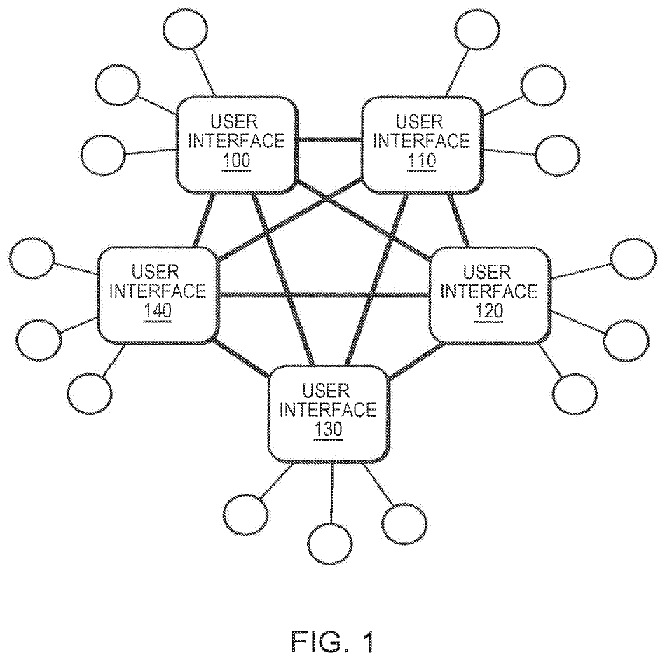

FIG. 1 illustrates an example decentralized network, in accordance with an embodiment of the present disclosure. Unlike a centralized network, the decentralized network does not require information to pass through a single point. Instead, the decentralized network is more of a peer-to-peer network.

In an example embodiment, the decentralized network is comprised at least of the plurality of user interfaces 100 through 140. Each of the user interfaces 100-140 provides a dashboard to a contributor. The contributor may be, for example, developers, solution architects, quality engineering team members, and/or product owners.

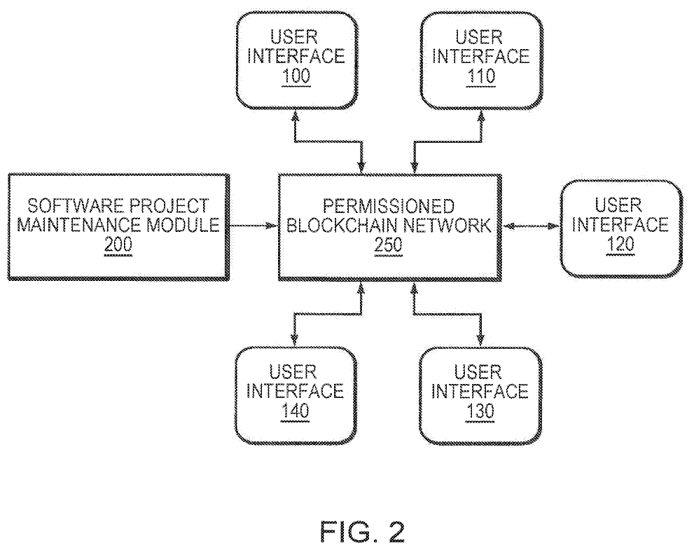

FIG. 2 an example of an embodiment of maintaining a software project in computing environments, in accordance with an embodiment of the present disclosure. In an example embodiment, any changes made in the software project trigger the software project maintenance module 200 to broadcast the changes to a peer-to-peer permissioned blockchain network 250. In an example embodiment, each node is a contributor having access to a user interface 100-140. Each contributor may accept or reject the changes that are broadcast by the software project maintenance module 200. The software project maintenance module 200 provides access to the transactions that are occurring in the software project so that the contributors may view the transactions through the use of a dashboard. The dashboard provides access for the contributors to view the transactions, such as changes made in the software code, the current ownership of the software code, the defect status, etc. In an example embodiment, each contributor has a copy of the transactions.

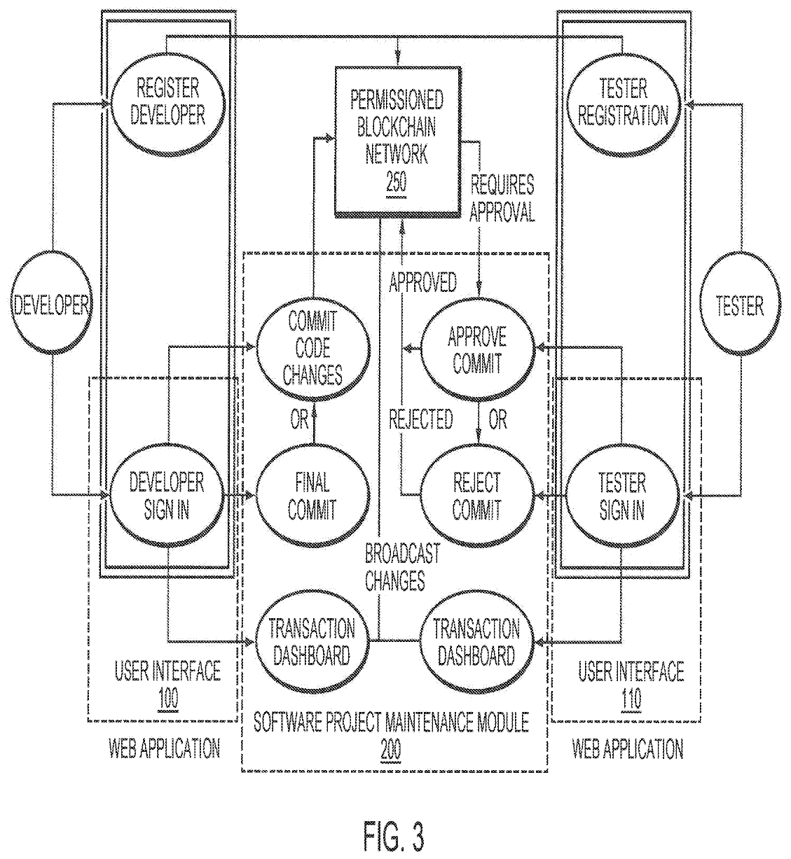

FIG. 3 illustrates an example flow chart of maintaining a software project, in accordance with an example of the present disclosure. In an example embodiment, each contributor can access a dashboard through a user interface, where each contributor may register as a contributor and sign in as a contributor (i.e., developers, solution architects, quality engineering team members, and/or product owners). Upon completion of contributor registration, the software project maintenance module 200 creates a block in the permissioned blockchain network 250. In an example embodiment, a contributor registers, signs in, and is able to commit software code changes within the software project. Committing the software code changes triggers an approval process within the software project maintenance module 200. To commit the software code changes, all contributors must approve the changes. If not, the software code changes will not be committed within the software project. In an example embodiment, the contributors may track each software project individually.

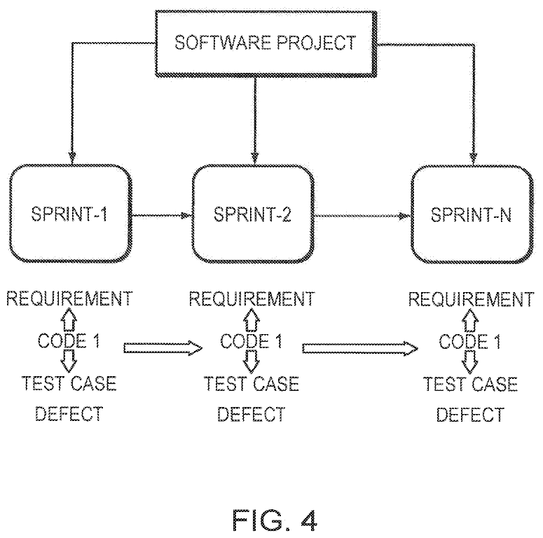

FIG. 4 illustrates an example embodiment of linking transactions using the blockchain network, in accordance with an embodiment of the present disclosure. A software project may span a period of time, and may be split into multiple sub projects, such as sprints. For example, a software project that spans 1 year may have several sprints throughout the year (for example, Sprint-1 through Sprint-N). Each sprint may have information such as what requirements changed, the software code developed for that requirement(s), the test cases for the software code, and any defects. Through the use of the permissioned blockchain network 250, the origins, ownership, etc. of the software project may be traced. In an example embodiment, the links between the sprints may be created, for example, using software lifecycle management programs. Through the permissioned blockchain network 250, the latest version of, for example, a portion of the software code may be viewed, as well as an older version of the same portion of the software code. In other words, a software developer may, through the use of the linked blockchain network, view the software code changes that have occurred from Sprint-1 through Sprint-N.

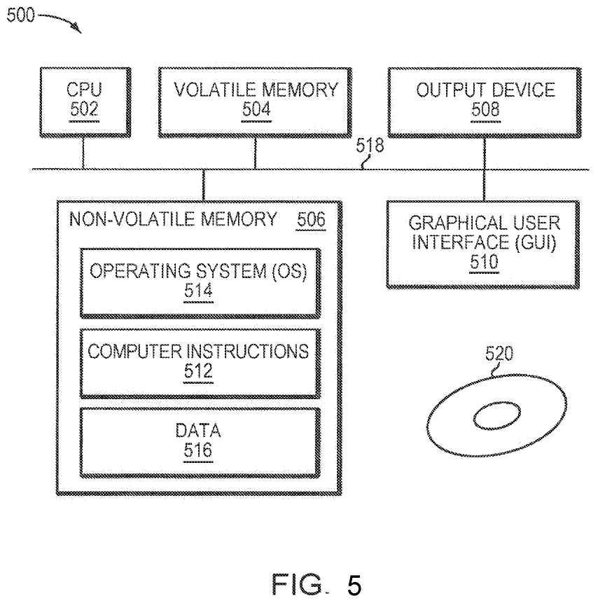

FIG. 5 illustrates a block diagram of a computer 500 that can perform at least part of the processing described herein, according to one embodiment. The computer 500 may include a processor 502, a volatile memory 504, a non-volatile memory 506 (e.g., hard disk), an output device 508 and a graphical user interface (GUI) 510 (e.g., a mouse, a keyboard, a display, for example), each of which is coupled together by a bus 518. The non-volatile memory 506 may be configured to store computer instructions 512, an operating system 514, and data 516. In one example, the computer instructions 512 are executed by the processor 502 out of volatile memory 504. In one embodiment, an article 520 comprises non-transitory computer-readable instructions. In some embodiments, the computer 500 corresponds to a virtual machine (VM). In other embodiments, the computer 500 corresponds to a physical computer.

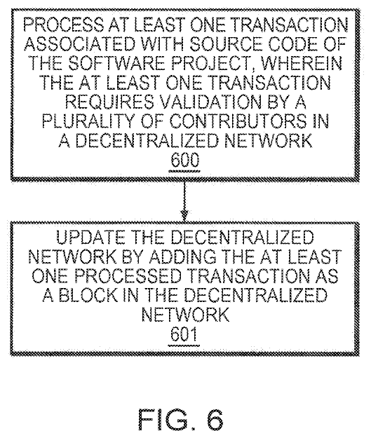

Referring to FIG. 6, shown is a more detailed flow diagram illustrating maintaining a software project in computing environments. With reference also to FIGS. 1-5, the software project maintenance module 200 processes at least one transaction associated with source code of the software project, where one or more transactions requires validation by a plurality of contributors in a decentralized network (Step 600). In an example embodiment, the transaction is a requirement change to the software project, and the requirement change is committed when all the contributors have validated the requirement change. For example, the requirement change may be a modification to the source code of the software project. The modification is committed when all the contributors have validated/approved of the modification to the source code.

The software project maintenance module 200 updates the decentralized network by adding the processed transaction as a block in the decentralized network (Step 601). In an example embodiment, the decentralized network is a permissioned blockchain network, and the transaction is a block in the permissioned blockchain network 250. In an example embodiment, the software project maintenance module 200 accesses the transactions that are taking place on a business network (for example, using an application program interface that accesses the software code associated with the requirement represented by the transaction) associated with the software project. The software project maintenance module 200 obtains the required data associated with the transaction from the source control software management system. For example, the software project maintenance module 200 may obtain the present state of the software code (and the software code defect, if one exists), the details associated with the environment in which the software code exists, and whether a software code defect is open/closed, etc. The software project maintenance module 200 may also compare the software code associated with the transaction with an earlier version of the software code to determine the changes, and the software project maintenance module 200 will reflect the detected changes. In an example embodiment, the software project maintenance module 200 connects to the deployed business network, which comprises the business logic and models, and performs create, read, update, and delete (CRUD) operations on the asset (i.e., the software code within the software project), and the contributors. The software project maintenance module 200 then submits the transaction.

In an example embodiment, the software project maintenance module 200 provides a user interface that allows each of the plurality of contributors to monitor the processing of the one or more transactions. In an example embodiment, all of the contributors have access to the transactions that are taking place within the software project through a dashboard. Each of the contributors has access to a dashboard. The dashboard assists the contributors in viewing the transactions, such as changes made in the software code, the current ownership of the software code, the defect status of the software code, etc. In an example embodiment, each of the contributors has a copy of the transactions. In an example embodiment, the software project maintenance module 200 accesses the transactions that are taking place on the business network (for example, using an application program interface that accesses the software code associated with the requirement represented by the transaction) associated with the software project to provide those transactions to the contributors through the dashboard provided to each contributor.

In an example embodiment, at least one transaction occurs within a predetermined time period. The transaction may be one or more transactions, for example, a set of transactions. In an example embodiment, software project maintenance module 200 adds a set of transactions to a block. For example, the software project maintenance module 200 may create blocks where any transactions that occur within a 24 hour period are added to a single block. In another example embodiment, the software project maintenance module 200 may add all transactions with a particular timestamp (or within a particular timestamp range) to a single block. In an example embodiment, there may be, for example, 10 transactions that are added to a block, for example, block A. Block A is linked to block B, which is linked to block C, and so on. In other words, each of the blocks in the permissioned blockchain network 250 are linked.

In an example embodiment, each of the plurality of contributors is added as a participant to the permissioned blockchain network, and provided with access to validate the transaction. In an example embodiment, adding a contributor to the permissioned blockchain network 250 is a transaction, and that transaction is added to a block in the permissioned blockchain network 250. The contributors who are involved with the software project, and who have access to the software code in the software project are, for example, the project owner, technical project manager, developer, tester, etc. In an example embodiment, each of the contributors is added to the permissioned blockchain network 250, and is then provided with the necessary access to create, read, update, and delete the software in the software project. In an example embodiment, the software project maintenance module 200 provides access to all previous and current transactions to each contributor as those contributors are added to the permissioned blockchain network 250. Thus, a newly added contributor has access to all transactions, and, for example, does not begin to work on a software defect that is also currently being handled by another one of the contributors.

In an example embodiment, a contributor is added to the permissioned blockchain network for transactions that the contributor is authorized to validate. To limit access for all the people involved in the software project, only necessary contributors are added to the permissioned blockchain network 250 in areas of the software project for which the contributor has access to validate.

In an example embodiment, the software project maintenance module 200 initiates the processing upon detecting a requirement change in the software project. In an example embodiment, the software project maintenance module 200 initiates processing the transaction automatically whenever there is a change in software code, and/or a change in the state of software code. In another example embodiment, the requirement may also be a requirement lock, a scope lock, a code lock, etc. In an example embodiment, the requirement change is any change to the software project. For example, adding or removing a contributor is also a transaction. Adding or removing a user of the software project is also a transaction.

In an example embodiment, the software project maintenance module 200 invokes processing the transaction when the processing is initiated by one of the contributors. In an example embodiment, the transaction processing may be invoked, for example, when a contributor moves software code from development to systems integration testing.

In an example embodiment, the transaction requires validation when the transaction is not occurring according to a predetermined schedule. For example, the software project maintenance module 200 detects a change in the software code of the software project, and/or the software project maintenance module 200 may detect that software code has been moved from the development stage/state to the systems integration stage/state. The software project maintenance module 200 then checks the business logic to determine if the change is happening according to a predetermined scheduled. If it is, then the transaction is successful, and the permissioned blockchain network ledger is updated for all of the contributors. If the change is not happening according to the predetermined schedule, for example, outside of the scope lock date, the software project maintenance module 200 requires approval from all of the contributors prior to processing the transaction. If all of the contributors approve the transaction, then the software code is moved from the development stage/state to the systems integration stage/state, and the permissioned blockchain network ledger is updated. If all of the contributors do not approve the transaction, then the software code remains in the development stage/state, and the permissioned blockchain network ledger is updated.

In an example embodiment, the transaction is a sub project of the software project, and the transaction (or set of transactions) is linked to at least one previous transaction in the decentralized network. In an example embodiment, at any point in time, a contributor may select the transaction, for example, through the user interface dashboard, and view the details of the transaction. The contributor may also trace back through previous transactions, such as sprints, that are linked as illustrated in FIG. 4. Thus, the contributor may trace back from any existing sprint to the start of the software project. For example, the software project team needs to determine where a problem occurred, and may need to trace back through the sprints to determine where the problem occurred. Or, when a new contributor joins the software project, the linked sprints allow the new contributor to step through the sprints of the software project to become familiar with the history of the software project.

In an example embodiment, each of the contributors may access each of the previous transactions. Thus, each of the contributors has visibility into the software code changes, and the associated impacted areas as the software code is tested, and is ready to be released.

Additionally, embodiments disclosed herein help to resolve requirement issues, and/or map gap issues after the code lock stage within the software development life cycle process. By maintaining governance using the permissioned blockchain network 250, no new, unknown software code is brought into the software project unless all of the contributors agree to the new software code. If not for the governance provided by the permissioned blockchain network 250, members of the software project may make a small change to the software code, and other members would not be able to block the software code modification.

In an example embodiment, each transaction (or set of transactions) comprises a code requirement, a portion of source code, and at least one test case. For each requirement of the software project, there is software code associated with the requirement. If a defect exists in the software code, there is a defect associated with the software code that is associated with the requirement. Embodiments disclosed herein present the state of software code/defect, such as which environment the software code exists in and whether the defect is open/closed, etc. Embodiments disclosed herein display the changes made to the software code. For example, the software project maintenance module 200 compares the existing software code with previous versions of the software code, and displays any changes. In an example embodiment, the software performs a comparison between the transaction (or set of transactions) and a previous transaction (or set of previous transactions).

In an example embodiment, the portion of source code is tokenized and available for re-use within the software project and/or another software project. In an example embodiment, a portion of the software code may be referenced with a token so that the portion may be more easily and quickly exchanged, or so that the portion of the software code may be subdivided into smaller units of value. This prevents developers from wasting time re-developing code that has already been developed. It also prevents developers from wasting time tracing through the software project to locate the re-usable portion of software code.

There are several advantages to embodiments disclosed herein. For example, the method provides a governance system for software projects source control, or for any process/environment that would benefit from a governance system for modifications/approvals. The method allows all contributors to have authority over a requirement change associated with a software project. The method provides a system for all contributors to be synchronized with the status of the software project. The method provides a platform where all the contributors are synchronized with each and every change that happens within the software project. The method provides a platform where each change to a software project happens with the mutual consent of all the contributors, where all the contributors are updated through a dashboard as each transaction occurs. The method links two (or more) sprints within the same software project. The method provides the ability to trace back from any existing sprint to the start of the software project. The method tracks requirement and/or software code changes, and presents the state of the software code/software defect using blockchain technology.

It should again be emphasized that the technique implementations described above are provided by way of illustration, and should not be construed as limiting the present invention to any specific embodiment or group of embodiments. For example, the invention can be implemented in other types of systems, using different arrangements of processing devices and processing operations. Also, message formats and communication protocols utilized may be varied in alternative embodiments. Moreover, various simplifying assumptions made above in the course of describing the illustrative embodiments should also be viewed as exemplary rather than as requirements or limitations of the invention. Numerous alternative embodiments within the scope of the appended claims will be readily apparent to those skilled in the art.

Furthermore, as will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

The flowchart and block diagrams in the FIGs illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been disclosed in connection with preferred embodiments shown and described in detail, their modifications and improvements thereon will become readily apparent to those skilled in the art. Accordingly, the spirit and scope of the present invention should be limited only by the following claims.

What is claimed is:

1. A method of maintaining a software project, the method comprising:
processing at least one transaction associated with source code of the software project, wherein the at least one transaction requires validation by a plurality of contributors in a decentralized network; and
updating the decentralized network by adding the at least one processed transaction as a block in the decentralized network.

2. The method of claim 1, further comprising:
providing a user interface allowing each of the plurality of contributors to monitor the processing the at least one transaction.

3. The method of claim 1, wherein the decentralized network is a permissioned blockchain network.

4. The method of claim 3, wherein the at least one transaction occurs within a predetermined time period.

5. The method of claim 3, wherein each of the plurality of contributors is added as a participant to the permissioned blockchain network, and provided with access to validate the at least one transaction.

6. The method of claim 5, wherein a contributor is added to the permissioned blockchain network for transactions that the contributor is authorized to validate.

7. The method of claim 1, wherein processing the at least one transaction associated with the source code of the software project comprises:
initiating the processing upon detecting a requirement change in the software project.

8. The method of claim 1, wherein processing the at least one transaction associated with the source code of the software project comprises:
invoking the processing by at least one of the plurality of contributors.

9. The method of claim 1, wherein the at least one transaction is a requirement change to the software project, and wherein the requirement change is committed when all the contributors have validated the requirement change.

10. The method of claim 1, wherein the at least one transaction requires validation when the at least one transaction is not occurring according to a predetermined schedule.

11. The method of claim 1, wherein the at least one transaction is a sub project of the software project, and wherein the at least one transaction is linked to at least one previous transaction in the decentralized network.

12. The method of claim 11, wherein each of the contributors may access each of the at least one previous transaction.

13. The method of claim 1, wherein each of the at least one transaction comprises a code requirement, a portion of source code, and at least one test case.

14. The method of claim 13, wherein the portion of source code is tokenized and available for re-use within at least one of the software project and another software project.

15. The method of claim 1, wherein updating the decentralized network by adding the processed at least one transaction as a block in the decentralized network comprises:
performing a comparison between the at least one transaction and a previous transaction.

16. A system for use in maintaining a software project in computing environments, the system comprising a processor configured to:
process at least one transaction associated with source code of the software project, wherein the at least one transaction requires validation by a plurality of contributors in a decentralized network; and
update the decentralized network by adding the at least one processed transaction as a block in the decentralized network.

17. The system of claim 16, further configured to:
provide a user interface allowing each of the plurality of contributors to monitor the processing the at least one transaction.

18. The system of claim 16, wherein the decentralized network is a permissioned blockchain network.

19. The system of claim 16, wherein each of the at least one transaction comprises a code requirement, a portion of source code, and at least one test case, wherein the portion of source code is tokenized and available for re-use within at least one of the software project and another software project.

20. A computer program product for maintaining a software project in computing environments, the computer program product comprising:
a computer readable storage medium having computer executable program code embodied therewith, the program code executable by a computer processor to:
process at least one transaction associated with source code of the software project, wherein the at least one transaction requires validation by a plurality of contributors in a decentralized network; and
update the decentralized network by adding the at least one processed transaction as a block in the decentralized network.
